(19) United States
(12) Patent Application Publication
(10) Pub. No.: US 2006/0037580 A1
(43) Pub. Date: Feb. 23, 2006

(54) Rotary heat engine

(76) Inventor: Ronald Francis Murawsky, Clearwater, FL (US)

Correspondence Address: Ronald F. Murawsky, 2320 Hawthorne Drive, Clearwater, FL, 33763, US

(21) Appl. No.: 10/921,618

(22) Filed: Aug. 20, 2004

(51) Int. Cl. F02B 53/04

(52) U.S. Cl. 123/223

(57) ABSTRACT

A rotary internal combustion engine with two opposing rotary discs, each having a half-cylindrical chamber located around its perimeter. An outer casing encompasses both rotary discs. Intake and exhaust ports and necessary engine controls are formed in said outer casing. A piston is formed in each said disc. Half of said piston is connected permanently to one said rotary disc the other half of said piston slides in the half cylindrical chamber of the opposing said disc. Said pistons and cylindrical chambers develop varying volumes in each chamber, depending on the position of each disc and respective piston. These varying volumes perform different cycles common to four stroke piston engines. Mechanical devises allow said discs to rotate in only one direction. Mechanical devises allow said disc to engage output shaft in only one direction.

### CROSS-REFERENCE TO RELATED APPLICATIONS

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### FIELD OF THE INVENTION

This invention relates to enclosed chamber rotary heat engines.

### SUMMARY

This invention performs all the necessary functions common to the internal combustion piston engine but its inherent design eliminates the main drawbacks associated with a reciprocating piston engine. Foreinstance, the main moving parts rotate, which maintains less stress on internal parts and less energy required to stop and start a piston moving on a linear path. Also the torque developed during the power stroke of this invention is greater than a reciprocating piston engine because the force on the momentum arm remains perpendicular for the duration of the power stroke.

### BRIEF DESCRIPTIONS OF THE DRAWINGS

FIG. 1 is a sectional view of a rotary disc;

FIG. 2 is a top view of a rotary disc;

FIG. 3 is sectional view of rotary disc;

FIG. 4 is a top view of rotary disc;

FIG. 5 is a sectional view of rotary disc;

FIG. 6 is a top view of rotary disc;

FIG. 7 is a sectional view of the exterior casing;

FIG. 8 is a top view of the exterior casing;

FIG. 9 is a sectional view of the exterior casing;

FIG. 10 is a top view of the exterior casing;

FIG. 11 is a front view of the output shaft;

FIG. 12 is a top view of the output shaft;

FIG. 13 is a componsite sectional view of the complete engine;

FIG. 14-17 skeletal drawing depicting the inner functions;

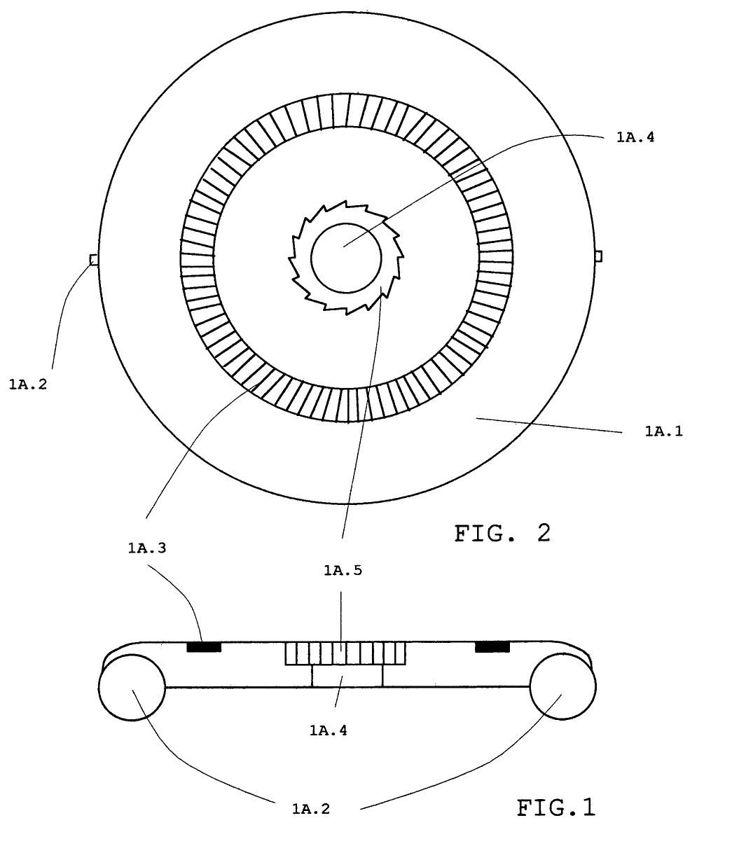

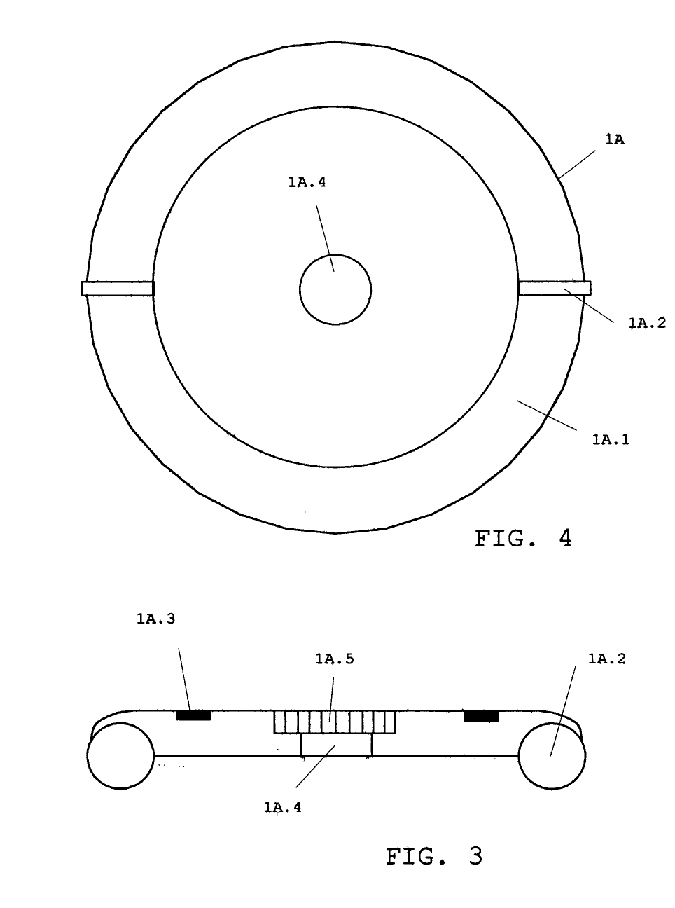

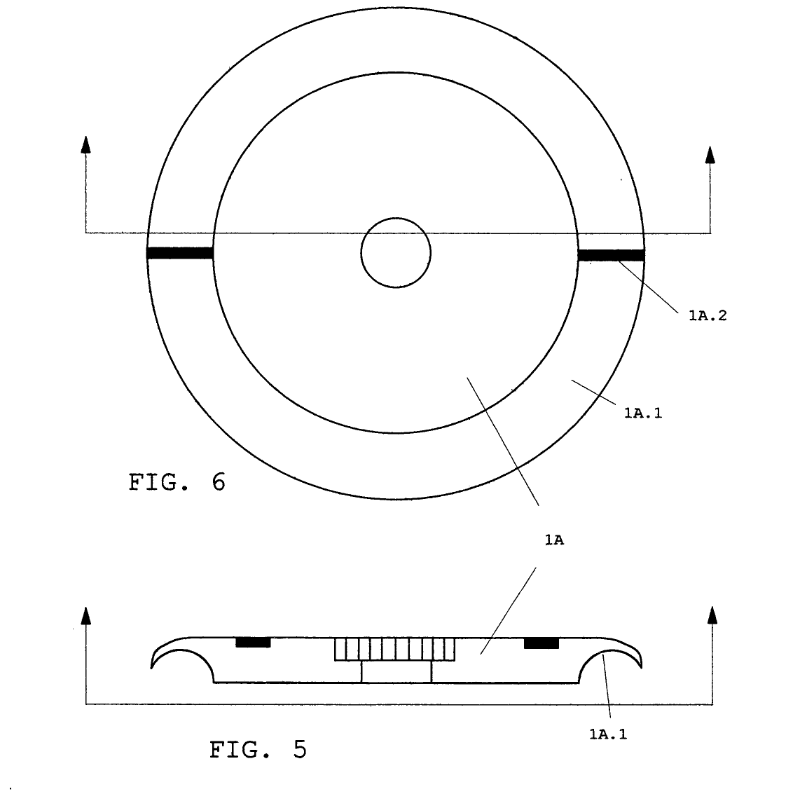

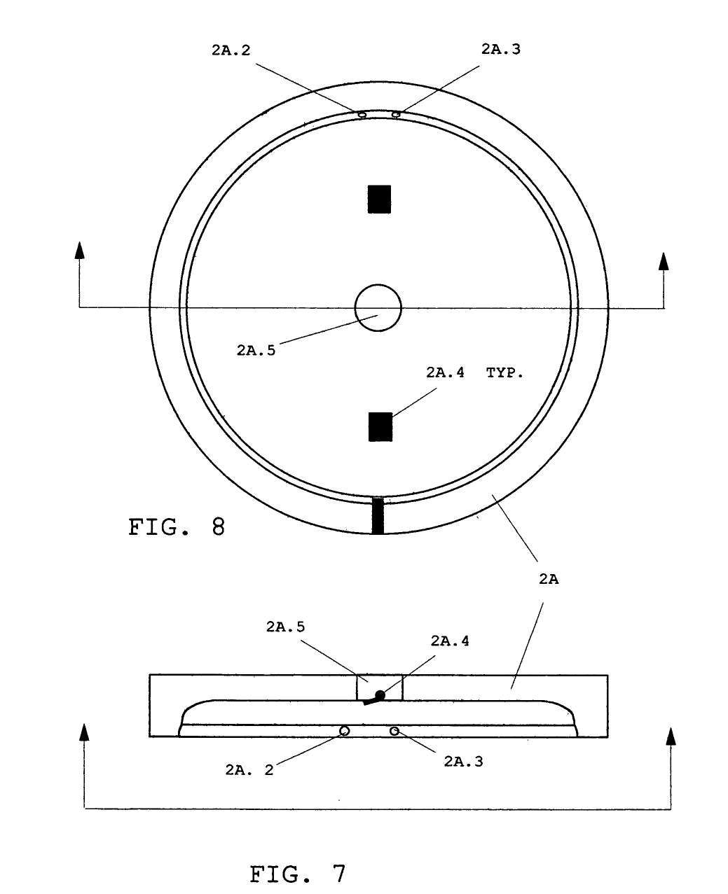

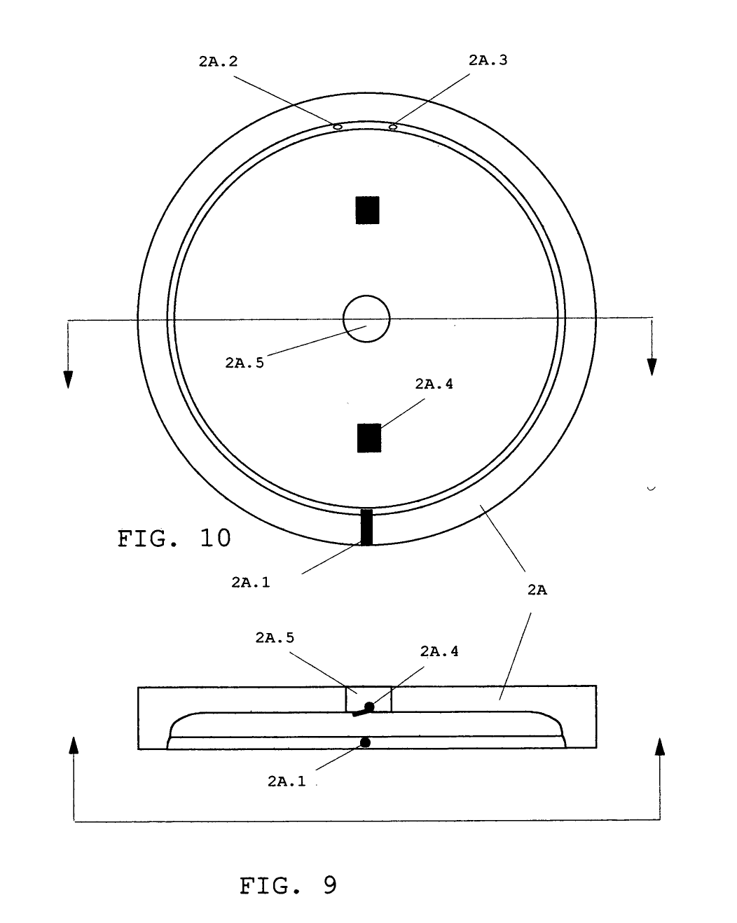

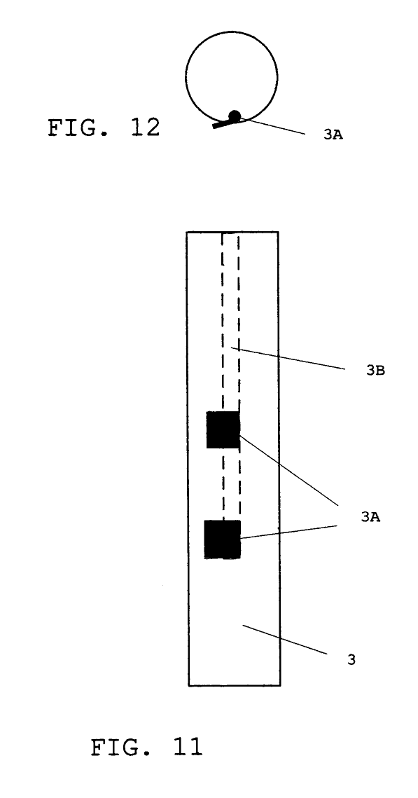

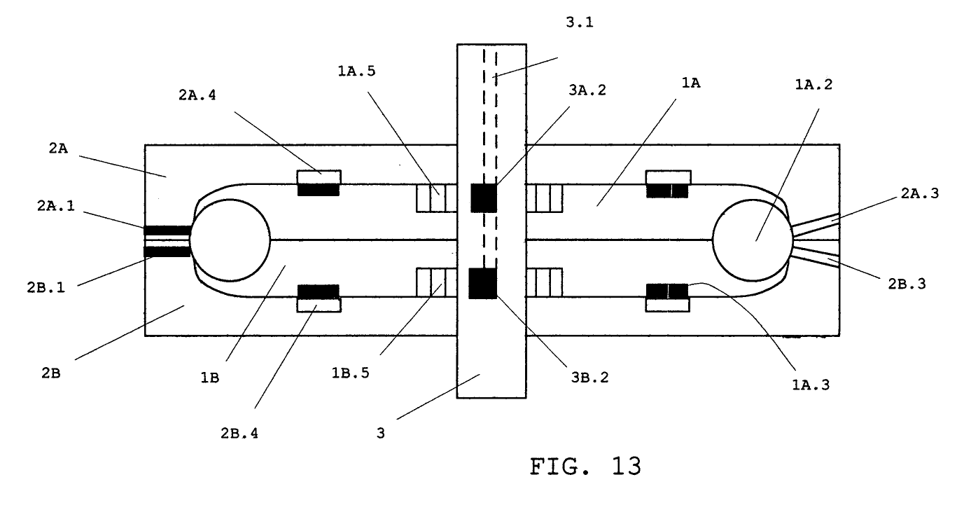

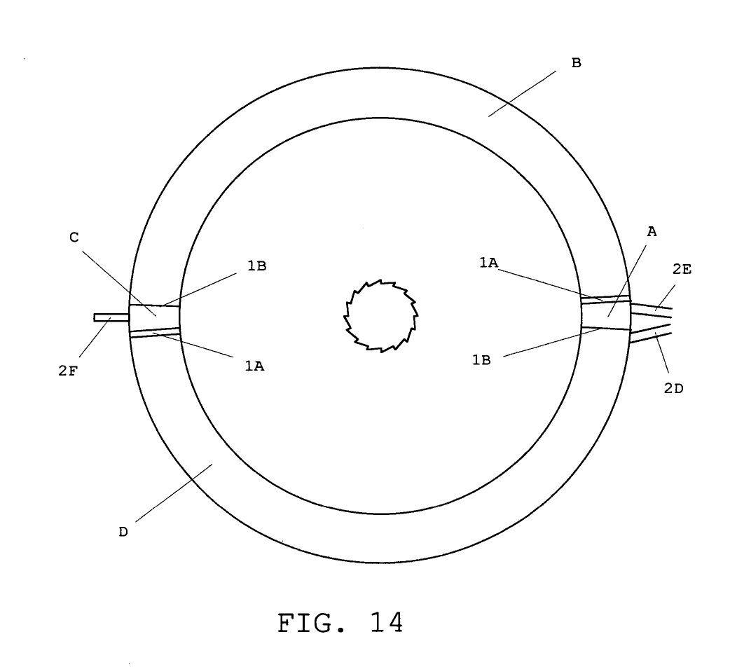

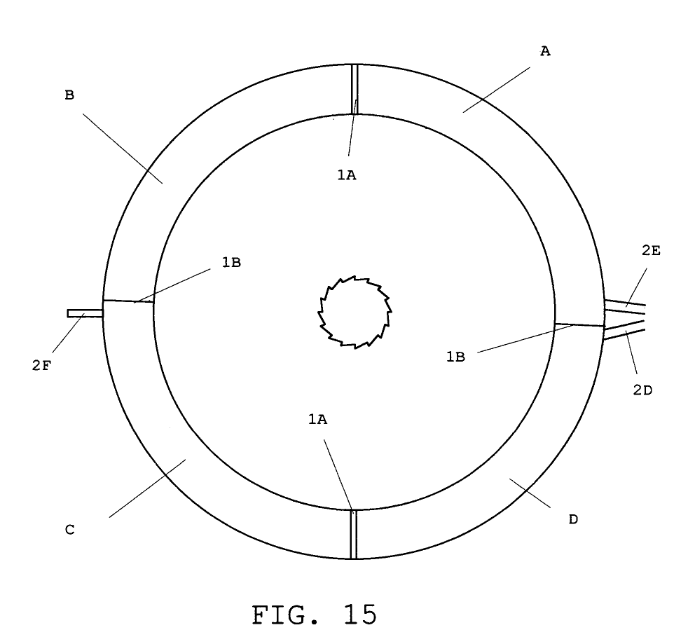

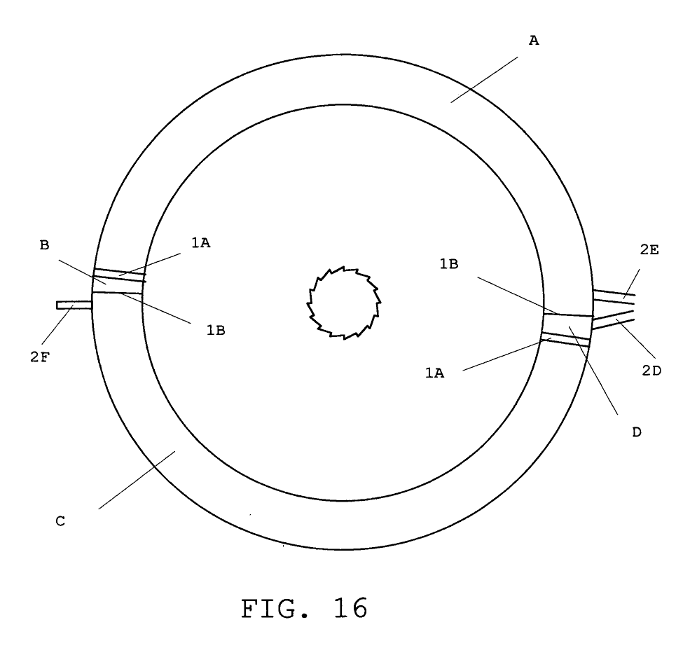

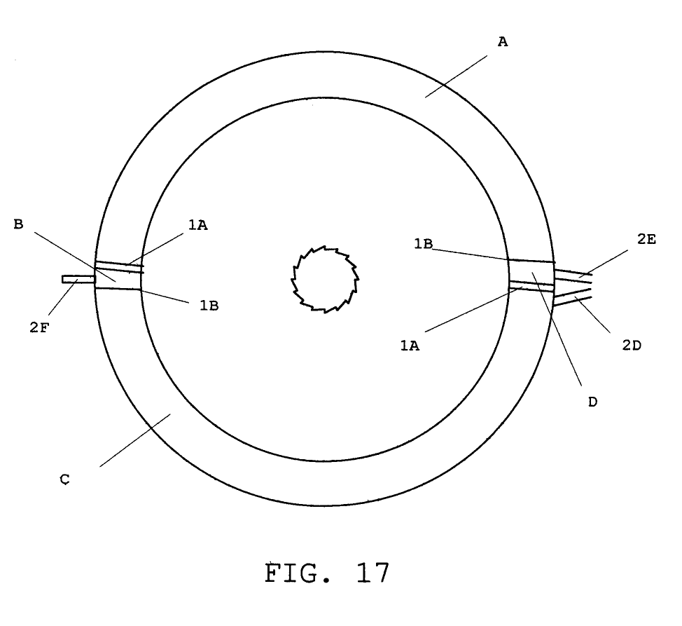

### DETAILED DESCRIPTION OF THE INVENTION

This invention relates to an internal combustion rotary engine that converts thermal energy into mechanical energy. Comprising of two opposing rotary discs 1A, 1B. Each formed with a half cylindrical chamber 1A.1, 1B.1 located around its perimeter. Located in chamber 1A.1, 1B.1 two perimeter pistons 1A.2, 1B.2 located approximately 180 degrees apart from each other. Approximately half of each piston is attach permanently to one rotary disc and the other half slides inside the chamber of the opposing rotary disc 1A and 1B respectively. Output shaft hole 1A.4, 1B.4 is located in the center of rotary disc 1A, 1B. Output shaft 3 passes through output shaft hole 1A.4, 1B.4. The center outer side of rotary disc 1A, 1B is located output shaft 3 ratcheting teeth 1A.5, 1B.5

Exterior casing 2A, 2B is formed to fit the exterior of rotary disc 1A, 1B. At least one spark plug 2A.1, 2B. 1 is form to the exterior of casing 2A, 2B. At least one intake port 2A.2, 2B.2 is formed approximately 180 degrees from spark plug 2A.1, 2B.1. At least one exhaust port 2A.3, 2B.3 is formed approximately 180 degrees from spark plug 2A.1, 2B.1. A circle of ratcheting teeth 1A.3, 1B.3 is formed on the exterior of rotary disc 1A, 1B. At least one ratcheting lever 2A.4, 2B.4 is aligned with ratcheting teeth 1A.3, 1B.3. Ratcheting teeth 1A.3, 1B.3 combining with ratcheting lever 2A.4, 2B.4 will allow rotary disc 1A, 1B to rotate in only one direction.

Output shaft 3 fits inside hole 1A.4, 1B.4, 2A.5, and 2B.5. Output shaft 3 incorporates ratcheting lever 3A.2, 3B.2. Ratcheting lever 3A.2, 3B.2 is aligned and works in conjunction with ratcheting teeth 1A.5, 1B5. This will allow rotary discs 1A, 1B to engage output shaft 3 while rotating in only one direction.

What I claim:

1. An enclosed chamber internal combustion engine comprises:
Two opposing rotary discs having at least one half-cylindrical chamber located around its perimeter;
At least one piston located in each said half cylindrical chamber.
Approximately half of each said piston is attach permanently to one said rotary disc and the other half of said piston is formed to fit inside the opposing said rotary disc.
The section of the said piston which is not permenately fixed to the said rotary disc slides in the said half cylindrical chamber of the opposing said rotary disc.
Sealing means provided in areas of said rotary disc for preventing said piston and said half-cylindrical chamber from fluid leakage.
Each said rotary disc is formed with a mechanism, which allows said rotary disc to rotate in only one direction.
Centered in said rotary disc is a passage, which allows an output shaft to rotate.
An exterior casing formed to fit the exterior of said rotary discs:
Said exterior casting is formed with a concentric passage, which allows said output shaft to rotate.
Said exterior casting is formed with at least one intake port and at least one exhaust port.
If necessary said exterior casing is formed with at least one spark plug.
Said output shaft and said rotary disc is formed with mechanisms which allow said rotary disc to engage
Said output shaft in only one direction.
